(19) United States
(12) Patent Application Publication
(10) Pub. No.: US 2007/0044399 A1
(43) Pub. Date: Mar. 1, 2007

(54) Window insulation apparatus

(76) Inventor: Sylvester Palko, Sarver, PA (US)

Correspondence Address: John P. Halvonik, Ste. 202, 15200 Shady Grove Rd., Rockville, MD, 20850, US

(21) Appl. No.: 11/202,668

(22) Filed: Aug. 15, 2005

(51) Int. Cl. E06B 3/26

(52) U.S. Cl. 52/202

(57) ABSTRACT

An insulation apparatus for home windows is shown and described. The invention comprises a plastic sheet that can be rolled down to use and can be rolled up when not in use. The sheet is joined to the sides of the window by a second part adhesive strips that are positioned around the edges of the window and window ledge. The strips have a either a plastic bead or a VELCRO mating portion on one side that permits them to be joined to a corresponding female or VELCRO portion on the insulation strip. Support straps are used to support the plastic sheet in a rolled up position along the top edge of the window when the apparatus is not in use.

### FIELD OF THE INVENTION

The invention relates to the field of insulation and in particular to insulation sheets used to cover windows in the home in order to provide a measure of insulation in winter time and other times when it is cold. The invention uses plastic “beads” like those found on ZIPLOCK bags (trademark name for plastic bags) in order to seal the insulation sheet around the four edges of the window. A series of four strips, having adhesive on one side, would be deployed around the edges of the window. Each of the strips has a corresponding bead on it that will mate with a corresponding portion on the insulation sheet. In this manner the insulation sheet may be deployed over the window and locked into place by means of the plastic beads. Alternatively, VELCRO (trademark name for hook and loop material) portions may be used in place of the beads. There would be adhesive on one side of the strip and a VELCRO portion on the other side.

There are roll up “ties” that are used to tie the insulation sheet into place when it is not in use. In that case, the sheet is rolled up, and the ties are used to wrap around the sheet and to hold it into place in the area above the window.

It is an object of the invention to provide an apparatus for insulating the area inside of windows in homes and buildings and to do so in a manner that allows the apparatus to be closed and re-closed without losing any functionality.

It is an object of the invention to provide a plastic insulation sheet in close connection with a window in order to insulate it in winter and to allow the insulation sheet to be rolled up when not in use.

Another object is to provide such as a plastic insulation sheet for windows that will be joined to the area around a window by a plastic bead that joins the sheet to the area around the window.

Other objects of the invention may be appreciated by those skilled in the art once the invention is shown and described.

### BACKGROUND OF THE INVENTION

It is thought that by providing a sheet of insulation over the front of a window will provide a useful amount of insulation that would result in a cost savings in winter time. People have been known to create such insulation barriers on an ad hoc basis by taping such sheets to the areas around the windows. It is thought that by providing a reusable means of connection (instead of connecting the sheet to the walls by ordinary tape) the resulting connection will be able to be re-used over a long period of time and will be more effective in terms of costs. Also the apparatus will be more easy to deploy as it it will not require constant re-taping and thus use up tape, etc. Instead the insulation sheet can simply be re-deployed and locked into place by means of the reusable connection.

It is thought that a plastic tongue and groove means of connection could be used as a means for re-closing the connection between the insulation sheet and the area around the window. Alternately, VELCRO portions could be used on the strips and they would be attached to the wall by the same adhesive means.

An example of such plastic bead means may be found on those sandwich bags that are sold under the name of ZIPLOCK (trademark name for re-closable sandwich bags) that use a “bead” that runs long the top edge of the bag and provides a re-closable means to seal the bag. The bead may be described as having a tongue, or, male shaped, portion running along the edge and that is designed to mate with a female shaped portion that runs parallel to the male portion and is located on the other flap of the sandwich bag. It is thought that such technology might find use in the present invention by providing a means to readily close the insulation sheet over the window and then to allow it to be unlocked when the sheet is no longer needed to insulate the window.

### DESCRIPTION OF DRAWINGS

FIG. 1 shows the overall view of the apparatus with the sheet about to be deployed in front of the window;

FIG. 2 cross section of mating strips using the bead element;

FIG. 3 overall view of the sheet as it would be deployed in order to show the mating sections.

FIG. 4 overall view of window and wall supported strips.

### DESCRIPTION OF PREFERRED EMBODIMENT

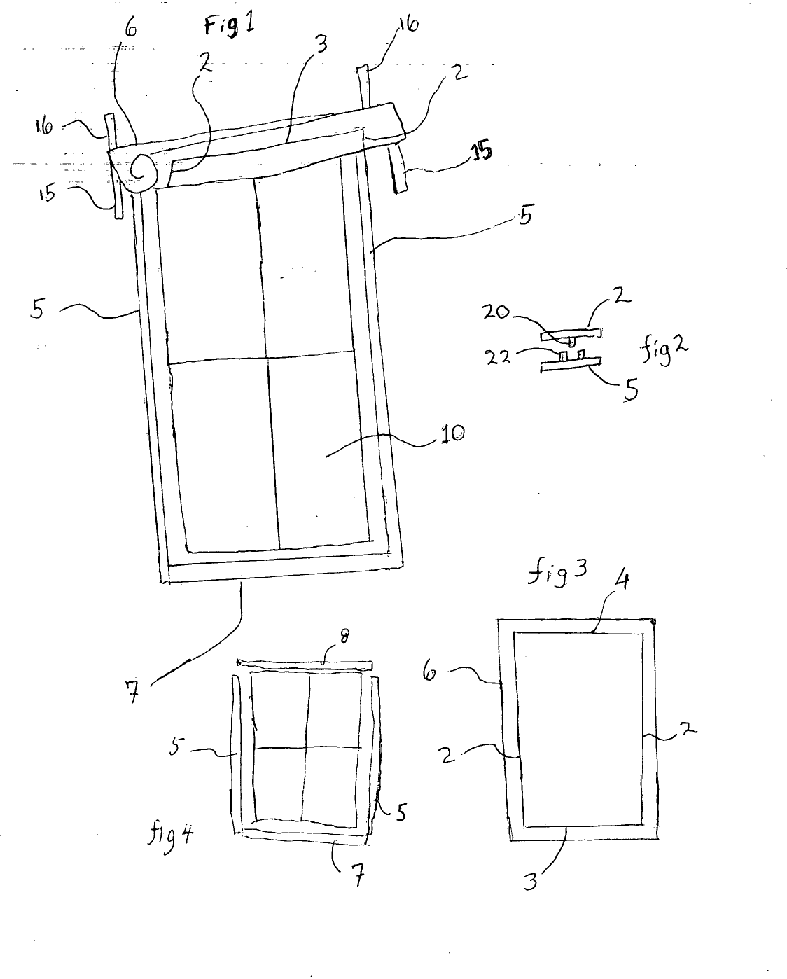

The overall construction of the apparatus is shown in FIG. 1. The adhesive sheet 6 may be in more or less permanently connection above the top edge of the window (window shown as 10 in FIG. 1). This connection can be by means of a plastic “bead” just like the connection used on the other three edges of the sheet or by VELCRO means. Plastic wall mounted strips 5, 7, and 8 are shown connected to the wall and are located around each of the four edges of the window as shown in FIG. 1. Number 7 runs across the bottom of the apparatus and would be just below the bottom edge of the window. Numbers 5 run along the sides of the window. 8 runs near the upper edge of the window in order to mate with the corresponding strip 4, near the top edge of the insulation sheet. The connection between 5 and 8 forms a more or less permanent connection of the sheet to the window area even though this will be the same type of connection as between the other wall-mounted strips and the sheet. These wall mounted strips can be attached either to the window frame or to the wall itself, either way is likely to be effective in the invention.

Each wall mounted strip should be of plastic and should have an adhesive coating on one side and in the case of the “bead” type; a plastic bead would be on the other side. In the case of VELCRO type wall mounted sttrips, a VELCRO portion would be on the other side. The bead portion 20 may be considered the male shaped locking portion as a matter of convention and the corresponding female portion 22 will be called the female portion. (detail shown in FIG. 2). Either the male or the female portion may be used on the strips 5, 7 and 8. Whatever type (male or female type) is chosen for the strip then the opposite, corresponding member must be used on the insulation sheet. For instance if the male type is used on the wall mounted strips, then the female shaped member must be used on the sheet connections (sheet connections shown as 2, 3 and 4 in FIG. 3) and vice versa.

The same reasoning is true when VELCRO is used for the wall mounted strips and the sheet connections. If the hook portion is used on the wall mounted strips then the hook type portion is used on the sheet connections and vice versa.

The adhesive side of the wall mounted strips should be of sufficiently strong adhesive power in order to support an insulation sheet throughout the winter season, at least. It is thought that the invention would be sold with a set of at least four adhesive strips and the strips would have a peelable backing layer on the adhesive side in order to preserve the adhesive until it is ready for use.

The sheet 6 is shown in FIG. 3 and should have a connecting means near each of the four edges of the sheet. 4 is the top connecting means, 2 are those on the sides and 3 is the one on the bottom. Again by connecting means it is meant either a bead means (described above) or a VELCRO type of connection; and if a bead is chosen it can be either male or female type and if VELCRO it can be either hook or loop type. Again whater type is chosen the corresponding portion will be used on the wall mounted strips.

When the sheet is not in use it will remain in connection with the upper edge of the window area. There will be a wall mounted strip 8 running along the upper edge of the window area, more or less permanently attached to the wall. Again one side will be adhesive in order to keep it to the wall or window frame. The attaching means 4 on the upper edge of the insulation sheet will be joined to this wall mounted strip. Thus, the upper edge of the sheet will be more or less in permanent connection to the upper strip. When not in use, then, this upper strip will offer the only means of connection of the sheet to the wall so it should be somewhat durable. That is because the sheet will be rolled up and not in connection with the other three adhesive strips.

When it is desired to deploy the sheet, such as in winter time or other times when it is cold, the sheet will be deployed downward and joined to the other three wall mounted strips. Those support straps 15 and 16 should be untied or unsnapped and the sheet 6 will deploy downward. The beads or VELCRO on the attaching means will then be used to attach each of the sides of the sheet to the wall mounted strips around the window. Thus the sheet will be once again joined along all four edges around the window for the wintertime.

When the sheet is not needed, such as in summer, or when it is not needed to insulate the window, the sheet will be rolled up with the top edge remaining in connection with the wall. As stated above, the sheet will be more or less permanently joined along the top connecting means 4, and it will be detached from the other three edges. So the sheet is detached along the three edges and it is then rolled up. Those support straps 15 and 16 shown in FIG. 1 are then wrapped around the rolled up sheet and used to support it in the rolled up position. The support straps may be tied or otherwise joined around the sheet and can then hold it in place in a rolled up position.

The straps 15 and 16 can use snaps or other means such as VELCRO etc. in order to connect one strap to the other. Alternately, the may be tied to one another. In the case of snaps, the snaps would be easy to use as they can simply be unsnapped and then the sheet will simply drop down over the window and be ready to be attached along the sides and bottom. There should be at least two sets of these straps, one on either side of the rolled up sheet.

I claim:

1. An insulation apparatus for use in connection with the area around a window; said apparatus comprising a first part comprising at least four wall mounted strips, each of said wall mounted strips having an adhesive layer on one side and having a connecting means on the other side, a second part comprising an insulating sheet of plastic and being in connection with the area above the top of said window, said sheet having four edges and having four corresponding connecting portions, each corresponding connecting portions running near each of said edges, so that said corresponding connecting portions may join said connecting means when said plastic sheet is deployed over said window; a third part comprising at least two sets of support straps, said set of straps having two straps of a combinded length sufficient to be joined around said sheet when said sheet is in a rolled up position.

2. The apparatus of claim 1 wherein said connecting means comprises a first VELCRO portion and said corresponding connecting portion comprises a VELCRO portion that is complimentary to said first VECLRO portion

3. The apparatus of claim 1 wherein said connecting means comprises a first bead portion and said corresponding connecting portion comprises a bead portion that is complimentary to said first bead portion where said bead portions comprise a male shaped tongue portion and a complimentary shaped female portion that can lock over said male portion.
